(19) United States
(12) Patent Application Publication
(10) Pub. No.: US 2026/0210892 A1
(43) Pub. Date: Jul. 23, 2026

(54) SENSOR AND COMPOSITION

(71) Applicant: TOHOKU UNIVERSITY, Sendai-shi, Miyagi (JP)

(72) Inventors: Takahito ONO, Sendai-shi (JP); Takaaki ABE, Sendai-shi (JP)

(21) Appl. No.: 19/139,515

(22) PCT Filed: Feb. 7, 2023
(86) PCT No.: PCT/JP2023/003953

§ 371 Date: Jun. 16, 2025

(51) Int. Cl. G01N 27/12; G01N 27/327

(52) U.S. Cl. CPC G01N 27/126; G01N 27/3272

(57) ABSTRACT

A sensor includes a sensor unit that detects a target substance in a liquid; current-voltage control means; and current-voltage measurement means, wherein the sensor unit includes first and second electrodes arranged adjacent to each other with a gap interposed between the first and second electrodes, and a composition disposed between the first and second electrodes and in contact with the first and second electrodes, the current-voltage control means and the current-voltage measurement means are electrically connected to the first and second electrodes, the composition includes a hydrophilic polymer, conductive fine particles, and an enzyme, the conductive fine particles and the enzyme are dispersed in the hydrophilic polymer, a content of the conductive fine particles to a total mass of the composition is a ratio in which the composition is in a percolation state on a mass basis, a product produced by a reaction between the target substance and the enzyme electrochemically interacts with the conductive fine particles, and an electric resistance value of the composition changes.

### TECHNICAL FIELD

The present invention relates to a sensor and a composition. In particular, the present invention relates to a chemiresistive sensor and a composition used for the chemiresistive sensor.

### BACKGROUND ART

An electrochemical sensor can be manufactured at a low cost, can facilitate measurement, and can provide rapid detection. However, since the electrochemical sensor requires a reference electrode and has a large electrode area, downsizing and cost reduction are limited. Among the electrochemical sensors, potentiometric sensors require a reference electrode for highly reliable potential measurement, and amperometric sensors require a reference electrode to apply an accurate potential for measurement. In the case of the potentiometric sensor, its response strongly depends on the stability of the reference electrode. However, a compact solid reference electrode with long-term stability has not yet been realized.

Recently, chemiresistive sensors, conductor metric sensors, electric field effect sensors, and the like have been developed to detect chemical substances.

The chemiresistive sensor is a resistance-type sensor that detects a target molecule by utilizing a change in resistance when the target molecule is adsorbed to a surface of a resistor. It can be said that the chemiresistive sensor is a simple method for measuring a chemical substance. The chemiresistive sensor is expected to be applied to the detection of a toxic substance, detection of a substance involved in a specific disease, and the like.

Patent Document 1 discloses a resistance-type biosensor in which an enzyme is immobilized on a single-walled carbon nanotube. More specifically, Patent Document 1 discloses that glucose oxidase is used as an enzyme, and hydrogen peroxide generated by an enzymatic reaction changes the electric resistance of the single-walled carbon nanotube to detect glucose.

In Non-Patent Document 1, polyaniline as a conductive polymer is used as a resistor, and glucose is detected using a resistance change accompanying a local pH change around the resistor. Glucose oxidase is dispersed in the resistor. A trace amount of platinum nanoparticles is added to oxidize hydrogen peroxide generated when glucose is oxidized by glucose oxidase. When glucose is present, hydrogen peroxide generated as a result of the enzymatic reaction reacts with a platinum catalyst, and the resulting hydroxide ions (that is, OH⁻) oxidize the conductive polymer to increase its resistance.

### CITATION LIST

### Patent Document

Patent Document 1: U.S. patent Ser. No. 10/031,102

### Non-Patent Document

Non-Patent Document 1: Edward Song, Tallis H. da Costa, Jin-Woo Choi, A chemiresistive glucose sensor fabricated by inkjet printing, Microsyst. Technol., 23 (2017) 3505-3511

### SUMMARY OF INVENTION

### Technical Problem

In the biosensor of Patent Document 1, its manufacturing method is complicated, and the biosensor does not necessarily have high detection sensitivity. Since the chemiresistive sensor of Non-Patent Document 1 uses a change in resistance of polyaniline due to oxidation, the detection sensitivity is low. In addition, since the chemiresistive sensor of Non-Patent Document 1 has a very slow response speed, detection takes about 200 seconds. A measurement range of the detectable glucose concentration is as narrow as from 0 to 10 mM.

An object of the present invention is to provide a sensor with high detection sensitivity and can be easily manufactured.

### Solution to Problem

The present invention includes the following aspects.

A sensor including: a sensor unit that detects a target substance in a liquid; current-voltage control means; and current-voltage measurement means, wherein the sensor unit includes first and second electrodes arranged adjacent to each other with a gap interposed between the first and second electrodes, and a composition disposed between the first and second electrodes and in contact with the first and second electrodes, the current-voltage control means and the current-voltage measurement means are electrically connected to the first and second electrodes, the composition includes a hydrophilic polymer, conductive fine particles, and an enzyme, the conductive fine particles and the enzyme are dispersed in the hydrophilic polymer, a content of the conductive fine particles to a total mass of the composition is a ratio in which the composition is in a percolation state on a mass basis, a product produced by a reaction between the target substance and the enzyme electrochemically interacts with the conductive fine particles, and an electric resistance value of the composition changes.

A composition including a hydrophilic polymer, conductive fine particles, and an enzyme, wherein the conductive fine particles and the enzyme are dispersed in the hydrophilic polymer, and the content of the conductive fine particles to the total mass of the composition is a ratio in which the composition is in a percolation state on a mass basis.

### Advantageous Effects of Invention

According to the above aspect, it is possible to provide a sensor that has high detection sensitivity and can be easily manufactured, and a composition used for the sensor.

### BRIEF DESCRIPTION OF DRAWINGS

FIG. 1 is a schematic diagram of a sensor according to an embodiment.

FIG. 2 is a plan view of a sensor unit according to an embodiment.

FIG. 3 is a cross-sectional view taken along line A-A′ of the sensor unit of FIG. 2.

FIG. 4 is a graph showing a resistance value of a mixture in atmosphere to a mass ratio of platinum nanoparticles in a mixture using polyvinyl alcohol and the platinum nanoparticles.

FIG. 5A is a schematic view for explaining a method of manufacturing the sensor according to an embodiment.

FIG. 5B is a schematic view for explaining the method of manufacturing the sensor according to an embodiment.

FIG. 5C is a schematic view for explaining the method of manufacturing the sensor according to an embodiment.

FIG. 5D is a schematic view for explaining the method of manufacturing the sensor according to an embodiment.

FIG. 5E is a schematic view for explaining the method of manufacturing the sensor according to an embodiment.

FIG. 6 is a top view of a sensor unit according to another embodiment.

FIG. 7 is a graph showing a resistance value to a glucose concentration in an aqueous glucose solution in the sensor of Example 1.

FIG. 8 is a graph showing a resistance value to a creatinine concentration in an aqueous creatinine solution in a sensor of Example 2.

### DESCRIPTION OF EMBODIMENTS

### First Embodiment

### Sensor

Hereinafter, embodiments will be described in detail with reference to the drawings.

However, the embodiments described below are merely examples, and there is no intention to exclude various modifications and applications of techniques that are not explicitly described in the embodiments. The sizes and ratios of the examples shown in the drawings are partially enlarged in order to facilitate understanding, and the shapes are also examples. These sizes, ratios, and shapes are not necessarily limited thereto. That is, the present embodiment can be modified and implemented in various ways without departing from the scope of the present embodiment.

A sensor according to an aspect of the present invention includes a sensor unit that detects a target substance in a liquid, current-voltage control means, and current-voltage measurement means.

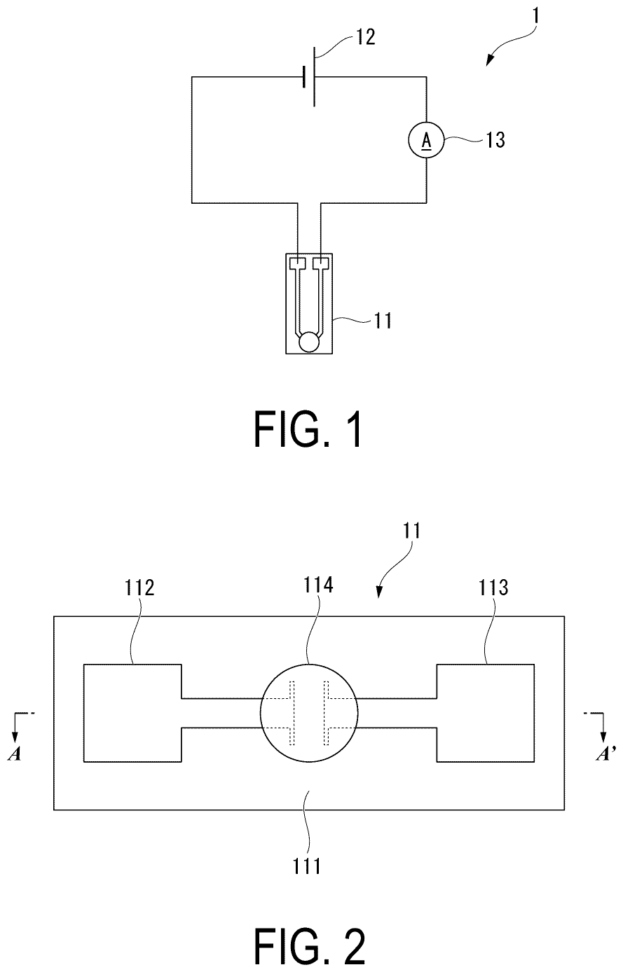

FIG. 1 is a schematic diagram of a sensor according to a first embodiment. The sensor 1 of the present embodiment includes a sensor unit 11, current-voltage control means 12, and current-voltage measurement means 13. The sensor unit 11, the current-voltage control means 12, and the current-voltage measurement means 13 are electrically connected.

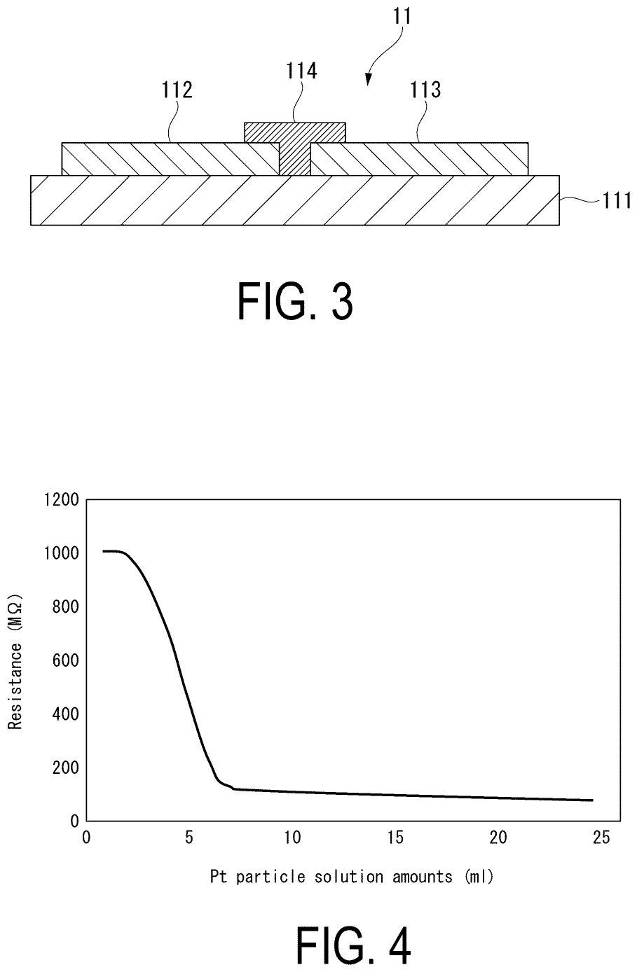

FIG. 2 is a plan view of the sensor unit 11 according to the first embodiment as viewed from a substrate 111 side. FIG. 3 is a cross-sectional view taken along the line A-A′ of the sensor unit 11 of FIG. 2. The sensor unit 11 of the present embodiment includes the substrate 111, a first electrode 112, a second electrode 113, and a composition 114.

As the substrate 111, an insulating substrate can be used, and for example, a glass substrate, a silicon substrate, a printed substrate, or the like can be used.

The first and second electrodes 112 and 113 are located on the substrate 111. The first and second electrodes 112 and 113 are arranged adjacent to each other with a gap interposed therebetween. The gap between the first and second electrodes 112 and 113 is preferably 10 to 100 μm. The first and second electrodes 112 and 113 are conductive metal thin films. The material of the conductive metal thin film is not particularly limited, and examples thereof include gold, silver, chromium, copper, and alloys thereof, and conductive carbon. The conductive metal thin film may be a single layer including the above material or a multilayer including two or more layers. The surfaces of the electrodes 112 and 113 are desirably protected with an insulating resin and the like in order to prevent leakage current.

The composition 114 is disposed on the first and second electrodes 112 and 113 and on the substrate 111 so as to fill the gap between the first and second electrodes 112 and 113. The composition 114 is in contact with the first and second electrodes 112 and 113. The composition 114 includes a hydrophilic polymer, conductive fine particles, and an enzyme. The conductive fine particles and the enzyme are dispersed in the hydrophilic polymer. In other words, the conductive fine particles spread throughout the gap between the first and second electrodes 112 and 113 at least without short-circuiting. The enzyme is preferably dispersed not only on a surface of the composition 114 but also throughout the composition 114, that is, inside the composition 114. Since the enzyme is also located inside the composition 114, a resistance value of the composition 114 is easily changed by a reaction between the enzyme and the target substance, and the detection sensitivity of the target substance is improved.

The hydrophilic polymer is an insulating hydrophilic polymer. As the hydrophilic polymer, polyvinyl alcohol, polyethylene glycol, polyvinyl acetate, cellulose fiber, and the like can be used, and polyvinyl alcohol is preferable. When the composition 114 contains the hydrophilic polymer, the target substance in the liquid and the enzyme are also in contact with each other inside the composition 114, so that the detection sensitivity of the target substance in water is improved. It is preferable that the hydrophilic polymer does not extend or contract due to the reaction between the enzyme and the target substance, and can stably hold the conductive fine particles.

A ratio of the hydrophilic polymer to a total mass of the composition 114 is preferably 20 mass % or more and 90 mass % or less. For example, in the case where metal fine particles are Pt having a diameter of 2 nm, when the ratio of the hydrophilic polymer to the total mass of the composition 114 is 30 mass % or more and 50 mass % or less, it is easy to control a mass ratio of the conductive fine particles in which the composition 114 is in a percolation state.

The conductive fine particles are preferably at least one of metal fine particles, graphite fine particles, and graphite fine wires. The metal fine particles mean metallic particles having a particle diameter of 1 to 80 nm. The particle diameter of the metal fine particle is preferably from 1 to 50 nm, and more preferably from 1 to 20 nm. The metal fine particles may be fine particles of metal having a catalytic action for promoting a decomposition reaction of an electrode active material (for example, when the target substance is creatinine, hydrogen peroxide water generated by a cascade reaction or the like) accompanying the reaction between the target substance and the enzyme, and are preferably noble metal fine particles. Specific examples of the noble metal fine particles include platinum nanoparticles, gold nanoparticles, silver nanoparticles, and palladium nanoparticles. Among them, platinum nanoparticles are preferable. The graphite fine particles mean from 10 to 90 nm graphite particles. The graphite thin wire means a thread-like graphite (that is, carbon nanofibers and carbon nanotubes) having a diameter of from 1 to 20 nm and a length of from 2 to 50 μm. In the present specification, the particle diameter means a median diameter (also referred to as D₅₀).

The mass ratio of the conductive fine particles contained in the composition is controlled so that the composition is in the percolation state. In a mixture in which conductive fine particles are added to an insulator such as an insulating polymer, the electrical conductivity changes as the ratio of the conductive fine particles increases. When the conductive fine particles exceed a certain ratio, a conductive path is formed by the fine particles coupled, and the electrical conductivity of the mixture rapidly increases. Such a rapid increase in electrical conductivity is called a percolation phenomenon. A region where the electrical conductivity changes rapidly is very sensitive to a slight carrier change. In the present embodiment, it is possible to provide a sensor with excellent sensitivity by using a region where the electrical conductivity of the mixture rapidly changes when a certain ratio is exceeded. In the present specification, the phrase “the composition is in the percolation state” means that the composition contains and disperses the conductive fine particles at a ratio in a range in which the above-described rapid change in electrical conductivity occurs with a change in density of the conductive fine particles.

When a resistance value R of the composition in the present embodiment is too large, noise increases, and the composition is not suitable for measurement. Thus, when a resistance value of a water-soluble polymer when a constant current or voltage is applied is R₁, and a resistance value in a state where conductive fine particles are excessively added to the water-soluble polymer is R₂, the resistance value R is preferably in a range of 2.0×R₂≤R≤0.8×R₁, and more preferably a value of (R₁+R₂)/2.5≤R≤(R₁+R₂)/1.75.

For example, FIG. 4 is a graph showing the resistance value of a mixture in the atmosphere to a mass ratio of platinum nanoparticles in a mixture using polyvinyl alcohol as a water-soluble polymer and platinum fine particles as conductive fine particles. The measurement voltage is 0.5 V. The horizontal axis represents an addition amount of 4 mass % of platinum nanoparticles added deionized water based on 3 mL of 4 mass % of polyvinyl alcohol-added deionized water. In this example, a resistance value R₁ is 1000 MΩ, and a resistance value R₂ is 100 MΩ. The resistance value R of the mixture is preferably a value around 600 MΩ, and for example, is preferably 480 MΩ or more and 685 MΩ or less.

The mass ratio of the conductive fine particles in which the composition is in the percolation state is preferably a mass ratio at which the resistance value of a mixture of the water-soluble polymer and the conductive fine particles in the atmosphere is 200 MΩ or more and 800 MΩ or less, more preferably a mass ratio at which the resistance value is 300 MΩ or more and 750 MΩ or less, still more preferably a mass ratio at which the resistance value is 500 MΩ or more and 700 MΩ or less, and particularly preferably a mass ratio at which the resistance value is 550 MΩ or more and 650 MΩ or less.

In addition, the mass ratio of the conductive fine particles in which the composition is in the percolation state is preferably a mass ratio at which the resistance value of the mixture of the water-soluble polymer and the conductive fine particles in water is 0.01 MΩ or more and 10 MΩ or less, and more preferably a mass ratio at which the resistance value is 0.05 MΩ or more and 3 MΩ or less.

For example, when platinum nanoparticles are used as the conductive fine particles, the mass ratio of the conductive fine particles in which the composition 114 is in the percolation state is, as an example, preferably 30 mass % or more and 75 mass % or less, more preferably 35 mass % or more and 70 mass % or less, still more preferably 35 mass % or more and 65 mass % or less as the mass of the conductive fine particles to the total mass of the composition 114.

By controlling the mass ratio of the conductive fine particles contained in the composition 114 so that the composition is in the percolation state, the composition 114 exhibits a large resistance change even if an electrical change due to the reaction between the target substance and the enzyme is small, and therefore the sensitivity of the sensor is improved.

The enzyme is not particularly limited as long as it can be dispersed and carried in the hydrophilic polymer, and is an enzyme that generates the electrode active material in the reaction between the target substance and the enzyme, and an enzyme capable of detecting the target substance is suitably selected. The electrode active material generated by the catalytic reaction by the enzyme is oxidized or reduced by the conductive fine particles, which are an electrochemical catalyst, and exchanges charges with the conductive fine particles. Examples of the electrode active material include hydrogen peroxide, oxygen, ammonia, hydrogen, and carbon dioxide. Hydrogen peroxide is an electrode active material that contributes to both oxidation and reduction, and can exchange charges with conductive fine particles by the following reaction.

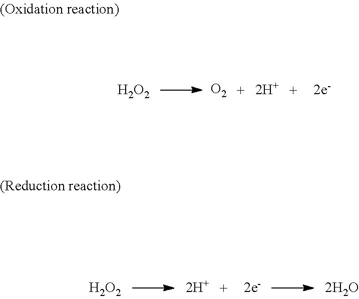

When hydrogen peroxide is oxidized, electrons are given to the conductive fine particles, when hydrogen peroxide is reduced, electrons are extracted from the conductive fine particles, and the conductive fine particles are positively ionized. For example, ammonia is used as an electrode active material that is oxidized and emits electrons, and conductive fine particles serve as an electrochemical catalyst and are oxidized. Alternatively, pH is changed by the following reduction reaction, and the electrical conductivity of the composition 114 changes.

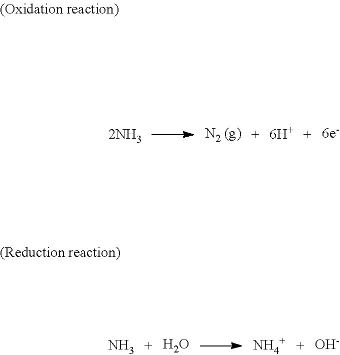

When the oxidation reaction is dominant, the conductive fine particles are negatively ionized, and depending on conditions, the electrons contribute to hopping conduction or tunneling conduction, so that the resistance of the composition 114 decreases. Alternatively, when a state in which the conductive fine particles are negatively charged by electrons is stable, a potential barrier is changed due to an influence of an electric charge due to charging of the conductive fine particles, and the electrical conductivity of the composition 114 may be reduced. When the reduction reaction is dominant, the conductive fine particles are positively ionized, and the resistance of the composition 114 is increased because the carriers contributing to electrical conduction are reduced. These oxidation-reduction reactions may occur simultaneously in the conductive fine particles, and in this case, in the composition 114 in which the conductive fine particles are dispersed, electric conduction occurs depending on the concentration of the electrode active material.

For example, an enzyme that generates hydrogen peroxide and a reaction example between the enzyme and a substrate are shown below.

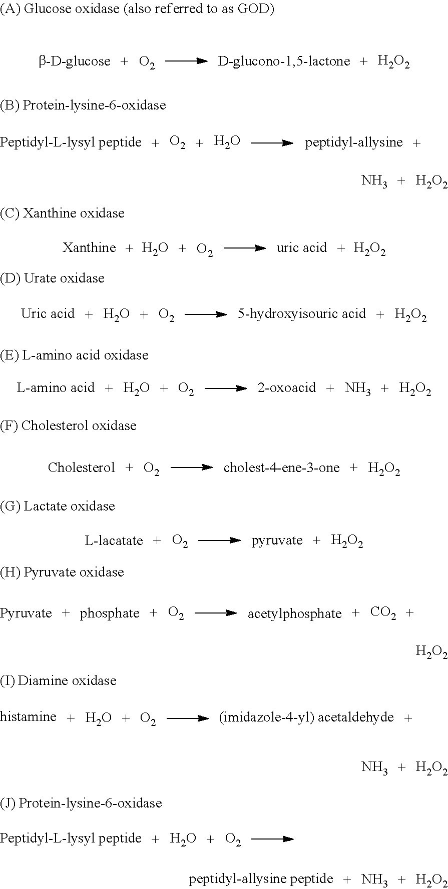

The enzyme may be one kind or two or more kinds. When two or more enzymes are used, hydrogen peroxide does not need to be generated in all enzyme reactions, and an electrode-active material may be generated in at least one enzyme reaction.

For example, when the target substance is creatinine, three kinds of creatininase, creatinase, and sarcosine oxidase can be used as enzymes.
(K) Creatininase, creatinase, and sarcosine oxidase

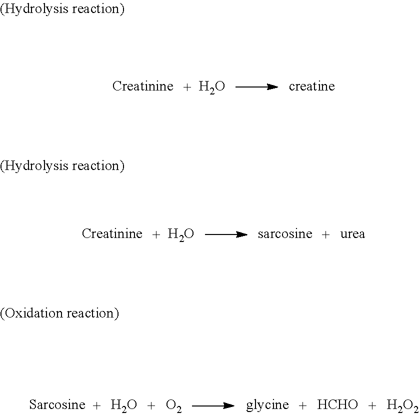

Examples of measuring creatinine using ammonia as an electrode-active material include the following.
(L) Creatinine iminohydrolase and creatinine deaminase.

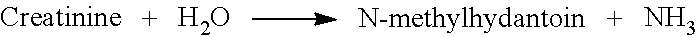

The mass ratio of the enzyme to the total mass of the composition 114 is preferably 0.01 mass % or more and 10 mass % or less, more preferably 0.02 mass % or more and 8 mass % or less, and still more preferably 0.05 mass % or more and 5 mass % or less.

As the current-voltage control means 12 and the current-voltage measurement means 13, a well-known electrochemical measurement device such as a potentiostat/galvanostat measurement station may be used.

The sensor 1 may further include a first estimation unit. The first estimation unit acquires a current-voltage curve by controlling the current-voltage control means 12 to apply a voltage to the composition 114 and controlling the current-voltage measurement means 13 to measure the current value at that time. The first estimation unit can estimate the electric resistance value of the composition 114 from the current-voltage curve.

The sensor 1 may further include a second estimation unit. The second estimation unit acquires a current-voltage curve by controlling the current-voltage control means 12 to apply a current to the composition 114 and controlling the current-voltage measurement means 13 to measure the voltage value at that time. The second estimation unit can estimate the electric resistance value of the composition 114 from the current-voltage curve.

The sensor having the above configuration can detect the target substance in the liquid with high sensitivity.

### Method for Detecting Target Substance by Sensor

A method for detecting a target substance by the sensor in the present embodiment will be described. The sensor unit 11 of the sensor 1 is immersed in a sample, which is a liquid containing the target substance. While the sample is slowly stirred, a constant current or voltage is applied using the current-voltage control means 12. As an example, a constant voltage is applied in the sensor 1, and a current value at that time is measured. A calibration curve of the current value to the mass ratio of the target substance per sample volume is prepared in advance, and the mass ratio of the target substance can be obtained from the measured current value. The electric resistance value can be estimated by the first estimation unit or the second estimation unit described above.

In addition to the above method, the target substance can be detected by the sensor in the present embodiment. For example, after immersing the sensor unit 11 of the sensor 1 in a sample containing the target substance, the current-voltage control means 12 may scan the sensor 1 with a voltage in a predetermined range, detect the current at that time by the current-voltage measurement means 13, and estimate the electric resistance value of the composition 114 from the current-voltage curve obtained as a result of the detection. Alternatively, the current-voltage control means 12 may scan the current flowing through the sensor 1, detect the voltage at that time by the current-voltage measurement means 13, and estimate the electric resistance value of the composition 114 from the current-voltage curve obtained as a result of the detection.

Instead of the method of slowly stirring the sample containing the target substance, the sample may be continuously brought into contact with the sensor 1 by flowing or circulating a liquid sample of the target substance. In this case, a liquid feeding pump, a syringe pump, or the like may be used in order to realize them.

### Method of Manufacturing Sensor

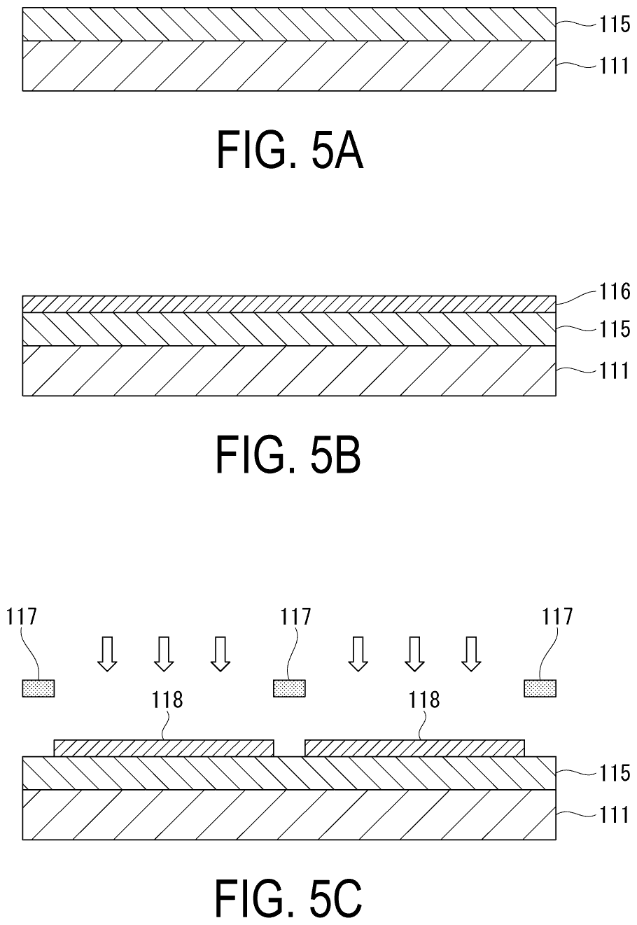

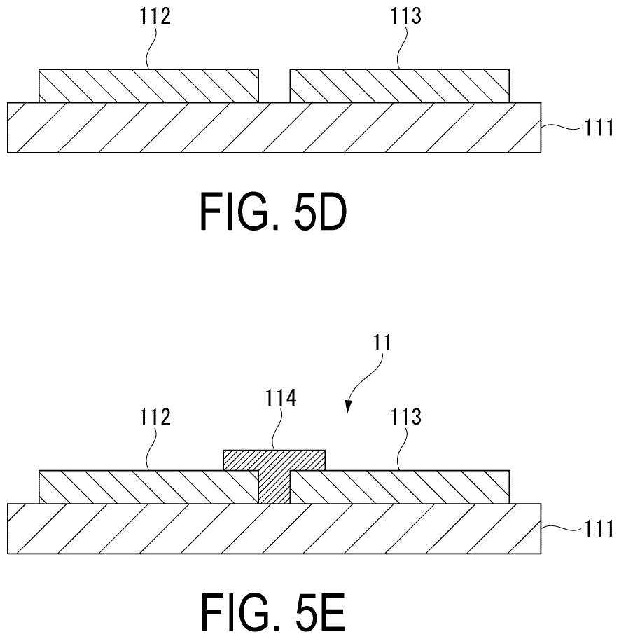

Hereinafter, an example of a method of manufacturing the sensor 1 of the present embodiment will be described with reference to FIGS. 5A to 5E.

As shown in FIG. 5A, a conductive metal thin film 115 is formed on the substrate 111. Examples of a method for forming the conductive metal thin film 115 include sputtering. In the present embodiment, although the conductive metal thin film 115 is formed as a single layer, the conductive metal thin film 115 may be a multilayer including two or more layers. As the material of the conductive metal thin film, the above-described material can be used.

As shown in FIG. 5B, a photoresist layer 116 is formed on the conductive metal thin film 115. As a photoresist, a positive type resist may be used, or a negative type photoresist may be used. As the positive type resist, for example, OFPR800 available from Tokyo Ohka Kogyo Co., Ltd. can be used. As the negative type resist, for example, OMR83 available from Tokyo Ohka Kogyo Co., Ltd. can be used. In the present embodiment, an example using the positive type photoresist will be described.

As shown in FIG. 5C, the photoresist layer 116 is irradiated with ultraviolet rays through a photomask 117. Thereafter, development is performed using a developer to form a photoresist pattern 118.

As shown in FIG. 5D, the conductive metal thin film 115 is etched through the photoresist pattern 118 to form the first and second electrodes 112 and 113. A metal etchant can be used as an etching solution.

A mixed liquid containing a hydrophilic polymer, conductive fine particles, and an enzyme is prepared. As an example, the hydrophilic polymer, the conductive fine particles, and the enzyme are weighed in consideration of a final mass ratio in the composition. The weighed hydrophilic polymer, conductive fine particles, and enzyme are each added to deionized water to prepare a hydrophilic polymer liquid, a conductive fine particle liquid, and an enzyme liquid, which can be mixed to prepare a mixed liquid. In the mixing, the conductive fine particles and the enzyme may be mixed so as to be dispersed as uniformly as possible in the hydrophilic polymer by using a known method.

As shown in FIG. 5E, the mixed liquid is dropped onto the first and second electrodes 112 and 113 and the substrate 111 so as to fill the gap between the first and second electrodes 112 and 113. A method of dropping the mixed liquid is not particularly limited, and is preferably an inkjet method. The mixed liquid is dropped and then dried to form the composition 114. In the composition 114 thus formed, the conductive fine particles are dispersed in the hydrophilic polymer, and the enzyme is supported on the hydrophilic polymer.

The first and second electrodes 112 and 113 are connected to the current-voltage control means 12 and the current-voltage measurement means 13 by wiring to complete the sensor 1.

### Second Embodiment

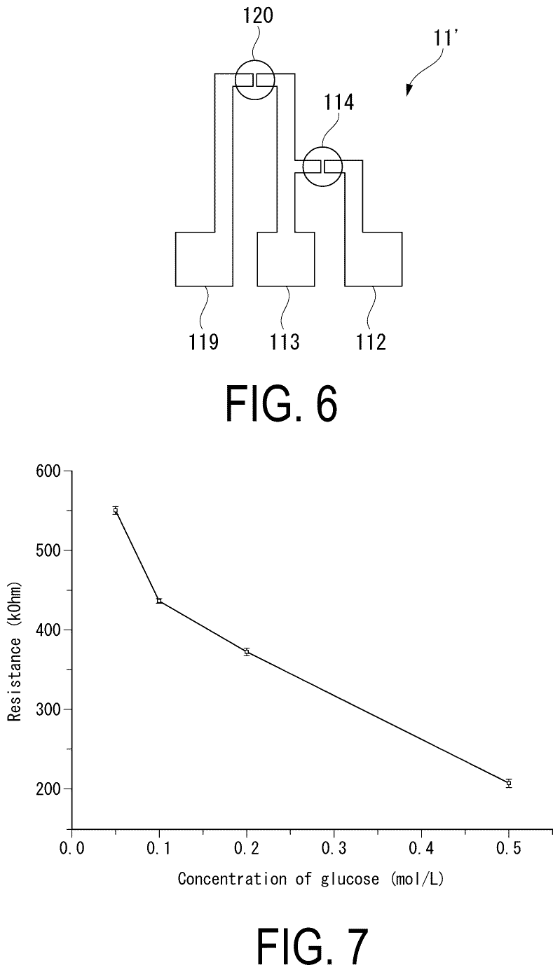

A sensor of the present embodiment is different from that of the first embodiment in a configuration of a sensor unit. Since the other configurations of the sensor are the same as those of the first embodiment, the description thereof will be omitted. FIG. 6 is a top view of the sensor unit according to the present embodiment. A sensor unit 11′ of the present embodiment includes first to third electrodes 112, 113, and 119, a composition 114, and a reference composition 120.

The second electrode 113 is disposed adjacent to the first electrode 112 with a gap interposed therebetween, and is disposed adjacent to the third electrode 119 with a gap interposed therebetween. The reference composition 120 is disposed on the second and third electrodes 113 and 119 and on the substrate 111 so as to fill a gap between the second and third electrodes 113 and 119. The reference composition 120 is in contact with the second and third electrodes 113 and 119.

The third electrode 119 is the same conductive thin film as the first and second electrodes 112 and 113. The reference composition 120 the same mixture of hydrophilic polymer and conductive fine particles as the composition 114 except that the reference composition contains no enzyme.

In the present embodiment, the first and second electrodes 112 and 113 and the composition 114 are target substance detection elements, and the second and third electrodes 113 and 119 and the reference composition 120 are reference elements. By subtracting the resistance value of the reference element from the resistance value of the target substance detection element, the resistance value of the composition 114 can be corrected, and an influence of fluctuation in the resistance value due to a contaminant in the sample containing the target substance can be suppressed.

### EXAMPLES

Hereinafter, the present invention will be further described with reference to examples, but the present invention is not limited to the examples at all.

### Example 1

A chromium thin film having a thickness of 20 nm was formed on a Tempax glass substrate by a sputtering apparatus (CFS-4ES available from Shibaura Mechatronics Corporation). A gold thin film having a thickness of 0.1 μm was formed on the chromium thin film by a sputtering apparatus (CFS-4ES available from Shibaura Mechatronics). A positive photoresist (available from Tokyo Ohka Kogyo Co., Ltd., product number: OFPR800-30CP) was applied onto the gold thin film, irradiated with ultraviolet rays through a photomask, and developed using a developer to form a photoresist pattern. Thereafter, metal was etched with gold and chromium etchant and patterned to produce the first and second electrodes. The shortest distance between the first and second electrodes was set to 50 μm.

A mixed liquid 1 was prepared by mixing platinum nanoparticles (available from TANAKA PRECIOUS METAL TECHNOLOGIES Co., Ltd., particle diameter: 2 nm) with deionized water. The amount of platinum nanoparticles was 4 mass % based on a mass of the mixed liquid 1. A mixed liquid 2 was prepared by mixing polyvinyl alcohol (available from FUJIFILM Wako Pure Chemical Corporation) with deionized water, and adding 0.6 wt. % of boric acid thereto in order to crosslink and stabilize polyvinyl alcohol. The amount of polyvinyl alcohol was 4 mass % based on a mass of the mixed liquid 2. A mixed liquid 3 was prepared by mixing 0.11 mg (30 mU) of glucose oxidase (available from NACALAI TESQUE, INC., product number: 16831-01) with 1 mL of deionized water.

A liquid obtained by mixing the mixed liquids 1 to 3 was added dropwise with a pipette so as to cover a gap between the first and second electrodes and end portions of the first and second electrodes, and dried at 45° C. for 60 minutes to form a composition having a thickness of from 5 to 10 μm. The first and second electrodes and the composition on the glass substrate thus formed were used as a sensor unit.

The first and second wirings were connected to the first and second electrodes, respectively. The current-voltage control means (available from Keithley Instruments, product number: 2400) and the current-voltage measurement means (available from Keithley Instruments, product number 2400) were connected so as to be connected between the first and second wirings, thereby manufacturing a sensor.

The sensor unit of the manufactured sensor was immersed in each of the aqueous glucose solutions having glucose concentrations of 0.05 mol/L, 0.1 mol/L, 0.2 mol/L, and 0.5 mol/L, a constant current of 640 μA was caused to flow by the current-voltage control means, and the resistance value of the sensor unit was obtained from the voltage value at that time. FIG. 7 is a graph showing the resistance value of the sensor unit to the glucose concentration in the aqueous glucose solution in the sensor of Example 1. It was found that the higher the concentration of glucose contained in the sample, the lower the resistance value of the sensor unit.

### Example 2

First and second electrodes were produced on a glass substrate by the method described in Example 1. A mixed liquid 4 was prepared by mixing 0.5 mg of creatininase (available from Sigma-Aldrich Co. LLC, product number: C3921-500UN), 5.7 mg of creatinase (available from Sigma-Aldrich Co. LLC, product number: C3172-1KU) and 2.3 mg of sarcosine oxidase (available from Sigma-Aldrich Co. LLC, product number: S7897-1KU) in 1 mL of deionized water.

A liquid obtained by mixing the mixed liquids 1, 2, and 4 was added dropwise with a pipette so as to cover the gap between the first and second electrodes and the end portions of the first and second electrodes, and dried at 45° C. for 60 minutes to produce a sensor unit. In the manufacturing method except for the sensor unit, the sensor was manufactured by the same procedure as in Example 1.

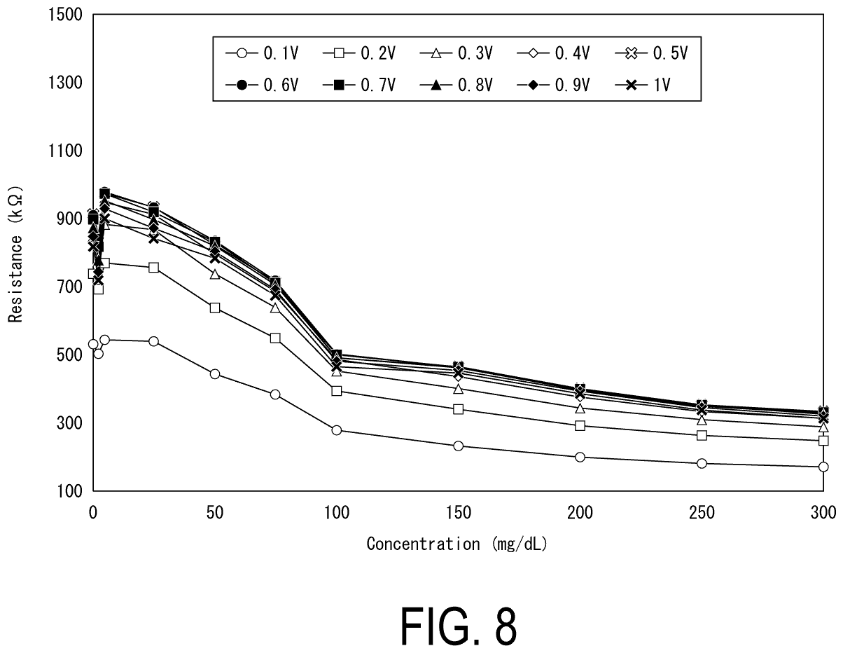

The sensor unit of the manufactured sensor was immersed in each of the aqueous creatinine solutions having creatinine concentrations of 0 mg/dL, 3 mg/dL, 6 mg/dL, 25 mg/dL, 50 mg/dL, 75 mg/dL, 100 mg/dL, 150 mg/dL, 200 mg/dL, 250 mg/dL, and 300 mg/dL, a voltage of from 0.1 to 1.0 V was applied in increments of 0.1 V by the current-voltage control means, and the resistance value of the sensor unit was obtained from the current value at that time. FIG. 8 is a graph showing the resistance value of the sensor unit to the creatinine concentration in the aqueous creatinine solution in the sensor of Example 2. It was found that the higher the concentration of creatinine contained in the sample, the lower the resistance value of the sensor unit.

In the above description, the measurement of glucose or creatinine has been described as an example of the target substance, but the target substance is not limited thereto. Examples of the target substance include peptidyl-L-lysyl peptide, xanthine, uric acid, L-amino acid, cholesterol, L-lactate, pyruvate, histamine, and peptidyl-L-lysyl peptide, and as the enzyme at that time, measurement can be performed by using each of protein-lysine-6-oxidase, xanthine oxidase, uric acid oxidase, L-amino acid oxidase, cholesterol oxidase, lactate oxidase, pyruvate oxidase, diamine oxidase, and protein-lysine-6-oxidase.

### INDUSTRIAL APPLICABILITY

According to the above aspect, it is possible to provide a sensor that has high detection sensitivity and can be easily manufactured, and a composition used for the sensor.

### REFERENCE SIGNS LIST

1: Sensor, 11, 11′: Sensor unit, 12: Current-voltage control means, 13: Current-voltage measurement means, 111: Substrate, 112: First electrode, 113: Second electrode, 114: Composition, 115: Conductive metal thin film, 116: Photoresist layer, 117: Photomask, 118: Photoresist pattern, 119: Third electrode, 120: Reference composition

1. A sensor comprising:
a sensor unit that detects a target substance in a liquid;
current-voltage control means; and
current-voltage measurement means,
wherein the sensor unit includes first and second electrodes arranged adjacent to each other with a gap interposed between the first and second electrodes, and a composition disposed between the first and second electrodes and in contact with the first and second electrodes,
the current-voltage control means and the current-voltage measurement means are electrically connected to the first and second electrodes,
the composition includes a hydrophilic polymer, conductive fine particles, and an enzyme,
the conductive fine particles and the enzyme are dispersed in the hydrophilic polymer,
a content of the conductive fine particles to a total mass of the composition is a ratio in which the composition is in a percolation state on a mass basis, and
a product produced by a reaction between the target substance and the enzyme electrochemically interacts with the conductive fine particles, and an electric resistance value of the composition changes.

2. The sensor according to claim 1, wherein the hydrophilic polymer is an insulating polymer.

3. The sensor according to claim 1, wherein the conductive fine particles are at least one of metal fine particles, graphite fine particles, and graphite fine wires.

4. The sensor according to claim 1, wherein the sensor unit further includes a third electrode disposed adjacent to the second electrode with a gap interposed between the second electrode and the third electrode, and a reference composition disposed between the second electrode and the third electrode and including a mixture of a hydrophilic polymer and conductive fine particles.

5. The sensor according to claim 1, further comprising a first estimation unit,
wherein the first estimation unit causes the current-voltage control means to apply a voltage to the composition, and causes the current-voltage measurement means to measure a current value at that time to acquire a current-voltage curve, and
the first estimation unit estimates the electric resistance value of the composition from the current-voltage curve.

6. The sensor according to claim 1, further comprising a second estimation unit,
wherein the second estimation unit causes the current-voltage control means to apply a current to the composition, and causes the current-voltage measurement means to measure a voltage value at that time to acquire a current-voltage curve, and
the second estimation unit estimates the electric resistance value of the composition from the current-voltage curve.

7. A composition comprising:
a hydrophilic polymer;
conductive fine particles; and
an enzyme,
wherein the conductive fine particles and the enzyme are dispersed in the hydrophilic polymer, and
a content of the conductive fine particles to a total mass of the composition is a ratio in which the composition is in a percolation state on a mass basis.
